(19) United States
(12) Patent Application Publication
(10) Pub. No.: US 2015/0006928 A1
(43) Pub. Date: Jan. 1, 2015

(54) DEVICE AND METHOD FOR CONTROLLING THE SUPPLY OF POWER TO PERIPHERALS

(71) Applicant: THOMSON LICENSING, Issy de Moulineaux (FR)

(72) Inventors: Philippe Guillot, Vern sur Seiche (FR); Xavier Guitton, La Chapelle des Fougeretz (FR); Philippe Marchand, Vitre (FR)

(21) Appl. No.: 14/372,017

(22) PCT Filed: Jan. 3, 2013
(86) PCT No.: PCT/EP2013/050073

§ 371 Date: Jul. 13, 2014

(30) Foreign Application Priority Data
Jan. 13, 2012 (FR) 1250341

(51) Int. Cl. G06F 1/26

(52) U.S. Cl. CPC G06F 1/266
USPC 713/320

(57) ABSTRACT

The invention relates to a device and a method for sequentially starting USB peripherals in order to optimise the supply of electrical power. Using current profiles corresponding to the start-up of peripherals, the connected peripherals are started one after the other. The delay between each start-up corresponds to the time necessary for the current consumption stabilisation of the peripheral being started. The profiles are stored by the device. During the start-up, the invention identifies the connected peripheral and searches for its start-up profile in the stored profiles, in order to determine the start-up delay to apply to the next peripheral.

### 1. DOMAIN OF THE INVENTION

The invention relates to a method for optimising the supply of electric power to USB ports.

In electronic devices equipped with several USB ports, the devices, when started, power all ports simultaneously and consequently all connected peripherals. The start-up of each of the peripherals results in an electrical current inrush and a peak which the power supply must be able to withstand. In the cases where several peripherals are connected simultaneously before the start-up, the electrical current peaks of each of the peripherals accumulate. The power supply must therefore withstand a significant current peak.

On this type of electronic device, the solution consists in connecting the USB peripherals, one after the other, thus avoiding the accumulation of current peaks.

### 2. PRIOR ART

FIG. 1 represents a current consumption on a device such as exists in the prior art. In fact, on a device equipped with USB ports, if several peripherals are connected when the device is switched on, this device, during the start-up phase of the connected equipment, powers these items of equipment almost simultaneously.

The start-up phase of many items of electrical equipment results in a current peak. The illustration of a standard start-up phase is shown on the graph by the current curve 110 of peripheral 1. This typical current curve enables identification of two parts in the current consumption of the equipment. Initially, there is a current inrush on the part of the peripheral to reach a peak 111, followed by a drop to the stabilised current consumption operational level 112.

When several items of equipment are present simultaneously on the device, and when these items of equipment are powered simultaneously, each item of equipment generates its own current peak, as described previously.

If two peripherals, peripheral 1 and peripheral 2 are connected, then there is an accumulation of current consumption during the start-up such as shown by the peak 121 and the value of the stabilised current 122 of the cumulative current curve 120. Likewise with three items of equipment, peripheral 1, peripheral 2 and peripheral 3, the peak 131 and the nominal consumption 132 of the cumulative current curve 130.

The maximum current consumption as described in FIG. 1 is the product of the peak current of a peripheral and the number of peripherals, assuming for simplicity that the current curves are identical. The formula for calculating the maximum current is therefore:

Imax=Ip*n equation: no. 1

Where: Ip=value of the start-up peak current of the peripherals

n=number of connected peripherals

However, in a more realistic context where each of the peripherals possesses a different current profile P, for the prior art, according to FIG. 1, the maximum total consumption is the sum of the peak currents of each of the peripherals and is calculated using the following formula:

Imax=Σₖ₌₀ⁿIpₖ equation: no. 2

Where: Ipₖ=value of the start-up peak current of the peripheral k

n=number of connected peripherals

The power supply must then withstand the total peak 131, the sum of the peaks of each peripheral, otherwise current protection on the part of the device will be activated and a new start-up procedure initiated.

Operation such as described in FIG. 1 has several disadvantages. As has been mentioned, the power specifications of the power supply for this type of device must provide for an accumulation of the currents of all peripherals which can be simultaneously connected. This approach in terms of electronic design is not conducive to producing energy-efficient products. In order to protect the electrical power supply part, products are currently equipped with a power supply capable of supplying a signal warning of power supply overflow. The standard behaviour of products when this signal is transmitted by the power supply is a forced re-start. With this type of solution, a new problem appears: the sequencing of start-up cycles of the device, as long as the current peak remains above the power supply limit.

### 3. SUMMARY OF THE INVENTION

The invention proposes to overcome at least one of the disadvantages of the prior art.

The invention relates to a device for controlling the supply of power to peripherals. It comprises at least 2 communication ports each able to electrically supply at least one peripheral, a processor and means for interrupting the supply of power to the peripherals. The processor is able to control the means for interrupting the power supply in order to sequentialise the start-up of the supply of electrical power to the communication ports.

Advantageously, the processor controls the means for interrupting the supply of power in order to delay supplying electrical power to at least a second peripheral by a time at least equal to a current consumption stabilisation time of the first peripheral.

Preferentially, the device comprises storage means, in order to store peripheral profiles. The processor is able to search amongst the stored profiles, a profile corresponding to the first peripheral.

Advantageously, the profile stored by the device comprises the stabilisation time and at least one identifier of the associated peripheral.

Advantageously, the communication ports are USB ports.

The invention also relates to a method for controlling the supply of electrical power to peripherals connected to an electronic device implementing the method. This method comprises the steps for:
detecting at least two peripherals connected to the device,
starting the first connected peripheral and,
sequentially starting the supply of electrical power to the other detected peripherals, each peripheral being started one after the other after a delay with respect to the supply of electrical power to another peripheral.

For this control method, the start-up step of each detected peripheral is broken down into steps for:
supplying power to the peripheral;
timestamping start-up;
obtaining a descriptor;
searching for a profile of the peripheral comprising a current stabilisation time

Preferentially, if during the search for the profile amongst the stored profiles, the profile is found, the temporal delay takes the value of the current stabilisation time.

Advantageously, if during the search for the profile amongst the stored profiles, the search is unsuccessful, the temporal delay takes a default delay value.

Advantageously, the default delay value is a constant value.

Preferentially, the default delay value is the product of the information of the maximum current consumed (bMaxPower) by the peripheral with a constant.

Advantageously, the peripherals are of USB type.

### 4. LIST OF FIGURES

The invention will be better understood and illustrated by means of non-restrictive embodiments and advantageous implementations, with reference to the accompanying drawings, wherein:

FIG. 1 shows a cumulative current consumption curve for a device simultaneously powering all the peripherals, according to the prior art,

FIG. 2 shows a current consumption curve for a device, according to a preferred embodiment of the invention,

FIG. 3 shows a block diagram of a device according to a preferred embodiment of the invention,

FIG. 4 shows an operation flowchart for a preferred embodiment of a device according to the present invention.

### 5. DETAILED DESCRIPTION OF EMBODIMENTS OF THE INVENTION

Initially, it is assumed that the current profile during the start-up of each peripheral is identical. This assumption is made notably for the value of the nominal operating current Is. Likewise, the peak current Ip during the start-up of each peripheral is identical, as is the current stabilisation time Ts. The purpose of this assumption is only to simplify the illustrations in the figures and in no way affects the description or the operation of the invention.

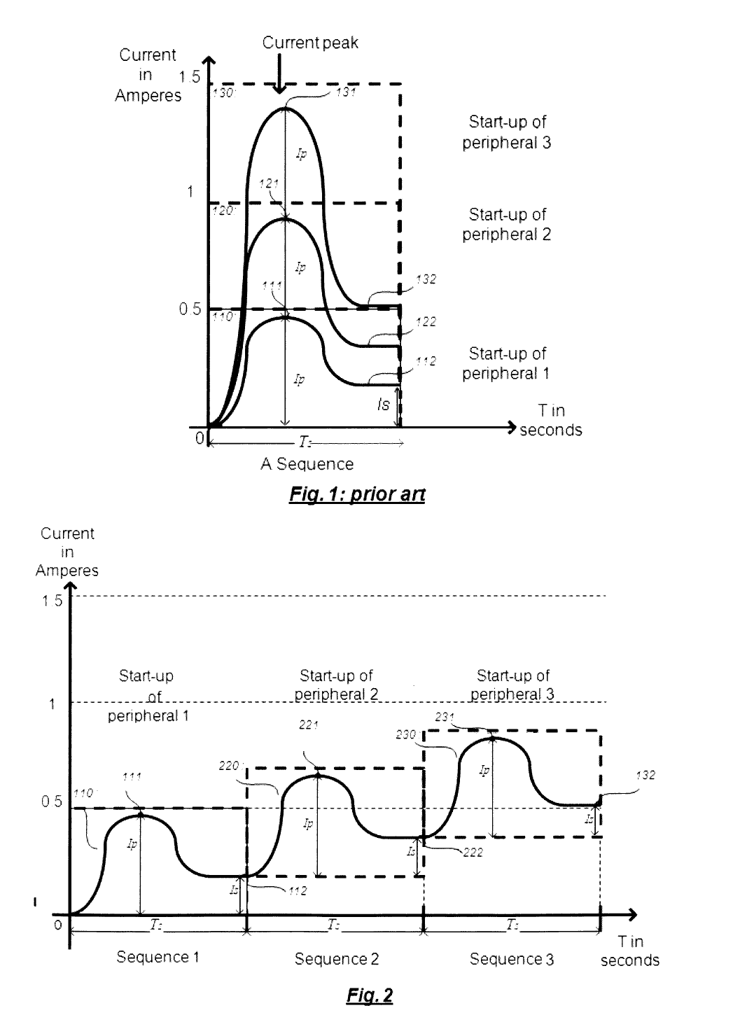

FIG. 2 shows the current consumption of a device operating according to the invention.

This figure is divided on the time axis, into three sequences, corresponding to the current consumption during the successive start-up steps of the peripherals. Examining the first sequence, sequence 1, shows the change in the value I of the current consumption during the start-up step of a first peripheral. This change in current as a function of time begins with a rapid increase corresponding to the current inrush caused by the start-up of the first peripheral. After reaching a maximum Ip, at a peak 111, the current consumption value I drops to a stabilised value Is of operating current I. This change in the value I of the current as a function of time, for the start-up phase, is called current profile P, or simply profile, illustrated by the current curve 110. The profile P is therefore notably characterised by the stabilisation time Ts of the current I. According to the assumption made here, the profile P of each peripheral (peripheral 1, peripheral 2 and peripheral 3) is therefore identical.

The device operating according to the preferred embodiment of the invention is equipped with several USB communication ports on each one of which is connected a peripheral. In the manner known to those skilled in the art, the device detects the presence of peripherals connected on the USB ports. In the example in FIGS. 1 and 2, three peripherals (peripheral 1, peripheral 2 and peripheral 3) are each connected on a USB port.

Unlike FIG. 1, the device incorporating the invention does not power all the peripherals at the same time. In fact, this device waits until the sequence, sequence 1, of start-up of the first peripheral is finalised, at the end of time Ts, by the stabilisation Is on the current consumption curve before proceeding to the start-up of the supply of power to the next peripheral, here sequence 2. According to the method of the invention, there is no longer an accumulation of each of the current peaks. The value of the peak 111 to which the power supply is subjected during the start-up of the first peripheral corresponds to the peak consumption Ip of this peripheral. However, since the second peripheral has its start-up delayed according to a time period Ts after the stabilisation of the current consumption of the first peripheral, the peak 221 is lower than the peak 121 of FIG. 1. The resulting peak 221 on the cumulative current curve 220, according to the invention, is equal to the sum of the current consumption of the first peripheral Is and the peak consumption Ip of the second peripheral.

Likewise, the transition to the start-up of the third peripheral in sequence 3 is delayed, until the start-up of the second peripheral is finalised, at the end of time Ts, by the stabilisation Is on the current consumption curve before proceeding to the start-up of the supply of power to the next peripheral. According to the method of the invention, the current peaks are offset in time and there is no longer an accumulation of each of the current peaks. The value of the peak 211 to which the power supply is subjected during the start-up of the second peripheral corresponds to the consumption peak Ip of this peripheral. However, since the third peripheral has its start-up delayed according to a time period Ts after the stabilisation of the current consumption of the second peripheral, the peak 231 is lower than the peak 131 of FIG. 1. The resulting peak 231 on the cumulative current curve 230, according to the invention, is equal to the sum of the current consumption Is of the first and second peripherals and the consumption peak Ip of the third peripheral.

Within the scope of our description and according to the assumptions previously made that the profiles are identical for all the peripherals, the maximum current consumption Imax according to the invention can be estimated by the following formula:

Imax=[Is*[n−1]]+Ip equation: no. 3

Where: Is=value of the stabilised nominal operating current
n=number of connected peripherals
Ip=value of the start-up peak current

In a more realistic context where each of the peripherals possesses a different current profile P and with the assumption that USB peripherals are started in an order of 0 to n, the formula for calculating the maximum current according to the invention is:

Imax=Σₖ₌₀ⁿ⁻¹Isₖ+Ipₙ equation: no. 4

Where: Isₖ=value of the stabilised nominal operating current of the peripheral k
n=number of connected peripherals
Ipₙ=value of the start-up peak current of the peripheral n

One of the advantages of the invention is to reduce the maximum electrical consumption of the device during the start-up of the peripherals. The gain Igain can be estimated by the difference between the maximum value (equation no. 2), consumed by a device according to the prior art and the maximum value (equation no. 4), consumed by a device according to the invention. The calculation is obtained with the following formula:

Igain=Σₖ₌₀ⁿ⁻¹(Ipₖ=Isₖ) equation: no. 5

Where: Isₖ=value of the stabilised nominal operating current of the peripheral k
n=number of connected peripherals
Ipₖ=value of the start-up peak current of the peripheral k

As shown in FIG. 2, the invention consists in proceeding to a sequential start-up of the USB peripherals connected to our device. Thus, each of the peaks is temporally delayed.

FIG. 3 shows a block diagram describing a preferred embodiment of the invention.

The description of the invention will be better understood with a brief reminder concerning the signals present on a USB port. This is illustrated in the bubble in FIG. 3. The USB is a serial bus comprising four insulated wires. The ports complying with the USB standard mounted on a device such as the invention comprise four pins. Two pins are dedicated to the supply of electrical power to the peripheral, respectively to the ground GND and the power supply voltage V_{BUS}. The standard specifies that the maximum current delivered by V_{BUS} is 500 mA. The two remaining pins carry the differential data signals D+ and D−, also called data lines.

The block diagram shows a device 1 comprising USB ports 30, 31 and 32, of means 20, 21 and 22, for interrupting the power supply for delivering the supply of electrical power and a processor 10. The processor 10 comprises time management means 12 and control means 11.

The means for controlled interruption of the power supply 20, 21 and 22 (also called means for supplying power) enable delivery or interruption on demand of the supply of electrical power V_{BUS} at each of the USB ports.

The time management means 12 (or waiting means) enable definition of the moment at which the supply of electrical power can be provided on a determined USB port.

The control means 11 of the USB ports (or control means) manages notably the distribution and supply using the means for interrupting the power supply 20, 21 and 22.

In the diagram, the use of an index ‘n’ for the notation on the means for supplying power 22 and the port 32, symbolises the possibility of equipping the device with as many ports as the USB standard allows. The invention imposes no restrictions on a maximum number of ports used. The invention is however only useful if the device is equipped with a minimum of two USB ports.

At the start-up of the device, none of the USB ports 30, 31 or 32 is electrically powered. The means for interrupting the power supply 20, 21 and 22 ensure no current is supplied on the V_{BUS} bus power supply lines. This state is controlled by the control means 11.

After the device 1 is switched on, the control means 11 detect the presence of a peripheral at a port by a potential variation on the data lines D+ and D−. This potential variation is due to the presence in the peripherals of pull-up resistors on each of the data lines D+ and D−. The control means 11 can then proceed to the start-up cycles of a USB peripheral. While complying with the specification of the USB standard, the control means can initially proceed to the detection of all connected USB peripherals, then move on to the start-up cycles. But the control means can also detect a first peripheral, then pass to the start-up steps of this peripheral and when these steps are finished, move to the detection of the next USB peripheral. The method of detection used has no impact on the invention.

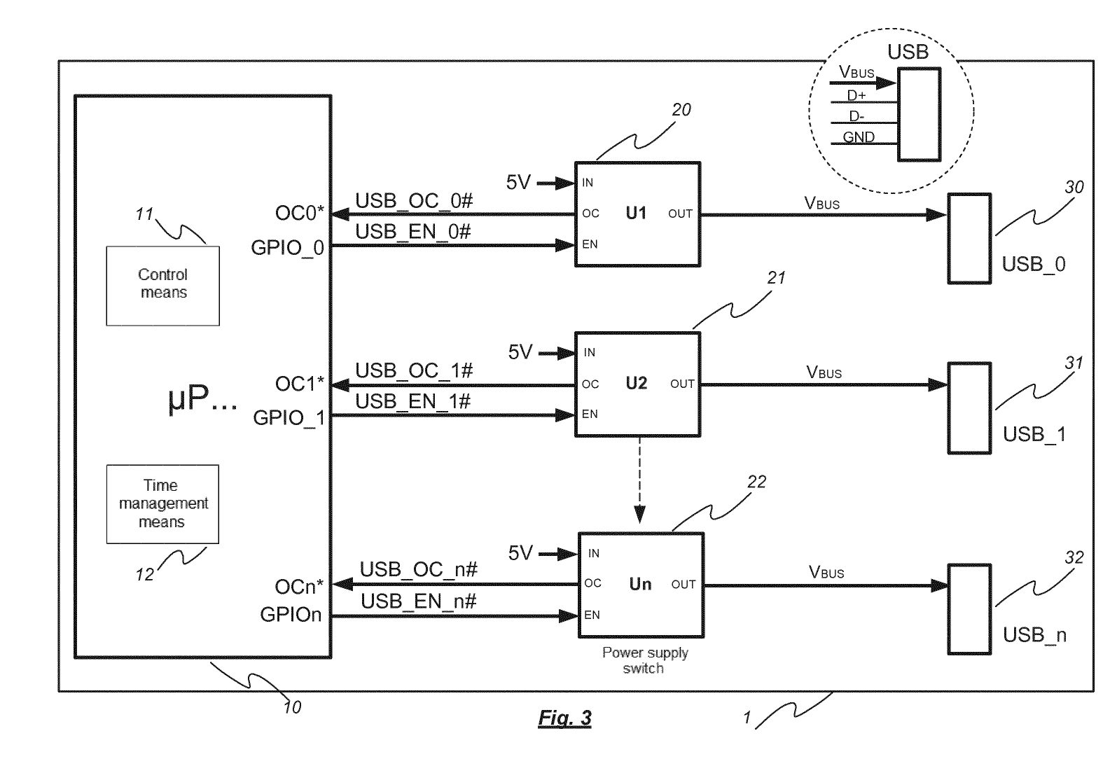

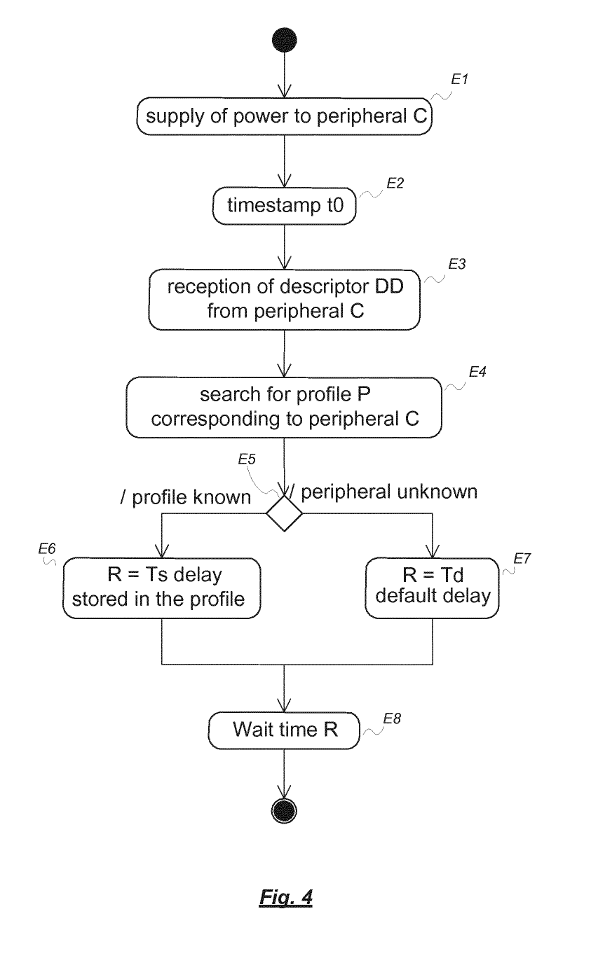

To illustrate the operation with an example, the presence of two peripherals on ports USB_{—}0 30 and USB_{—}1 31 is considered. The control means 11 detect the potential variation at port USB_{—}0 30. Then the control means 11 request this port USB_{—}0 30 to be supplied using the means for interrupting the power supply 20. The detailed actions by the control means 11 at this stage are described using the flowchart of FIG. 4. When the initialisation phase of the peripheral is finished, at the end of a delay Ts and notably with a stabilisation of the current Is, the control means 11 restarts the process with the next port, here in our example USB_{—}1 31.

By processor 10 is understood for example the use of a microcontroller. But this can also be obtained using a microprocessor, an SoC, an FPGA or an ASIC. For example, Intel's Groveland SoC provides the function perfectly. It should be noted that this example is non-restrictive and can be extended to all electronic devices.

The control means 11 as well as the time management means 12 are carried out for example using software bricks which are executed on the processor 10.

The means for interrupting the power supply 20, 21 and 22 are advantageously carried out by power supply switches. This type of switch is powered with a reference power supply present on the IN line. It possesses an EN line to authorise or prohibit the supply of electrical current on an output line OUT.

Preferentially, these switches possess an OC line to inform the control means 11 of a current overload on the output line OUT. The switches can for example be provided by components of the ST brand, under reference STMPS2141 or of the RICHTEK brand under reference RT9728A. However these means 20, 21 and 22 could be embedded in the processor 10, of type SoC, FPGA, etc.

FIG. 4 shows a preferred operational flowchart of the invention. The references used relate to the references of the means described in FIG. 3.

The device 1 possessing USB connection ports detects the presence of a peripheral C during its connection via the pull-up resistors on the peripheral C connected on the two data wires, generating a voltage variation. The principle of this detection already discussed in the previous figure is described in the USB specifications, detection is followed by enumeration. Enumeration is a method for identifying the peripheral during its connection, by the device 1, in order to identify the device which has just been connected by obtaining its characteristics and attributing an address to it, which it will use for the communications.

If a peripheral C has been detected for example on port 30, the device 1 proceeds in the following manner, complying with the enumeration specifications of the standard.

During a first step E1, the device 1 and its control means 11 power the peripheral C connected to port 30 using the means for interrupting the power supply 20, 21 and 22. Immediately the device, using the time management means 12, proceeds to a timestamping E2 to fix the reference time t0 of the start-up. This timestamping can be effected by any known method, such as saving the internal clock or saving the tick counter used by the operating system or the real-time kernel. It can also be obtained by using an event, fitting an alarm, using a counter or any other method known to those skilled in the art.

Then, the control means 11 while complying with the sequence of exchanges with the peripheral C receives during a step E3, a descriptor DD enabling the connected peripheral C to be identified.

Using the descriptor DD supplied by the peripheral C, during a step E4, the device 1 searches for the corresponding stored profile P. The purpose is to obtain a value of the delay time R between the beginning of the start-up of the current peripheral on port 30 and the beginning of the start-up of the next peripheral for example on port 31. This delay time R is later provided to the time management means 12. It corresponds to the time necessary for the current stabilisation of the peripheral being started on port 30. The value of the delay time R is fixed as follows:

If the search has been successful, during a step E5, the control means 11 use the data constituting the profile P and notably the stabilisation time Ts, in order to fix the delay time R, equal to Ts, step E6.

If the search has not been successful, the peripheral C is therefore unknown and the delay time value R takes a default value Td, step E7. The default value is fixed. But it can also be calculated from the information received with the descriptor of the peripheral, and advantageously the descriptor field bMaxPower which provides the maximum electrical consumption in graduations of 2 mA. It is then the product of bMaxPower with a constant.

Finally, during a last step E8, there is a check using timestamping t0 to see if the time elapsed since the power supply initiation of peripheral C is greater or less than the delay time R of the power supply stabilisation time. If the time elapsed is less, then the means for time management 12 allow the remaining time to elapse and thus delay the start-up of the peripherals not yet supplied. Otherwise, the time elapsed is greater than or equal to the delay time R, the start-up process of the first peripheral C is finished. It is then possible to move to the start-up of the next USB peripheral by repeating the detection phase if all of the connected USB peripherals have not previously been detected, then the start-up procedure, steps E1 to E8. Thus, the device 1 applies a sequential start-up of the peripherals such as described for FIG. 2, by supplying them with power one after the other. The peak currents Ip are therefore spaced out throughout the start-up phase.

A profile P is constituted from data enabling control of the start-up duration of the peripheral C to which it relates. These profiles are known and established by measurements carried out in the laboratory. The time Ts necessary for the current stabilisation during the start-up is notably measured. The maximum current Ip reached and the stabilised current Is are also measured. According to a preferred embodiment, the profile P comprises the value of the stabilisation time Ts. As we have seen previously, it is this value which serves to fix the temporal delay R in order to defer the supply of a next peripheral. In order to satisfy the search requirement, the profile P comprises an identifier ID enabling the peripheral C to be identified. This identifier ID is from the descriptor DD of the peripheral C. The comparison between the identifier ID from the descriptor DD transmitted by the peripheral C and those which are stored with the profile enable an efficient search.

Advantageously, the profile P can also comprise the maximum current value Ip during the current peak and the stabilised current value Is.

The choice from the list of profiles Ps to be stored is dependent on the device concerned. For example, for a multimedia device for audiovisual reception, such as a digital decoder, the manufacturer knows the list of peripherals which can be connected to its device. These are normally mass memories, such as flash memory sticks or USB hard disks. This manufacturer is therefore able to create a profile P for each device.

For the purposes of the invention, the profiles established in the laboratory are stored by the device 1. The means for storing the profiles are all means known to those skilled in the art. An example can be cited of storing profiles in a read-only memory (ROM), or in flash, under any form known as a file, a table or a linked list. The profile Ps can also be stored on any type of mass memory such as hard disks and be loaded in the random access memory, during the start-up of the device.

The identifier ID of the peripheral C is constituted from all information useful in the search, available in the descriptor provided by the peripheral C. For example, this can be done using the idProduct field and the id Vendor field, but also with the product class defined by the bDeviceClass field.

The invention applies for any device described as, for example, an item of multimedia equipment (television, digital decoder, etc.) but also a computer. It applied not only to any device equipped with USB ports, but also applies to other types of ports for external or internal peripherals, for which the electrical power supply is provided by the host connection port and for which a sequential start-up is not prohibited by the operating constraints of the host device.

1. (canceled)

2. (canceled)

3. (canceled)

4. (canceled)

5. (canceled)

6. (canceled)

7. (canceled)

8. (canceled)

9. (canceled)

10. (canceled)

11. Device for controlling the supply of power to a plurality of peripherals, said device comprising a plurality of communication ports adapted to supply electrical power to said plurality of peripherals, said device comprising a processor and means for interrupting the supply of power to said peripherals,
wherein said processor comprises:
powering means configured for powering said plurality of peripherals sequentially, said powering means comprising:
detecting means configured for detecting a peripheral on one of said communication ports,
starting means, configured for starting said detected peripheral, said starting means comprising:
obtaining means configured for obtaining a descriptor of said detected peripheral;
fixing means configured for fixing a temporal delay according to said obtained descriptor;
controlling means configured for controlling said means for interrupting, so as ensure that no power is supplied to a non-started peripheral until the time elapsed since the initiation of the power supplying of said detected peripheral is greater or equal to said temporal delay.

12. Device according to claim 11, wherein it further comprises storage means for storing consumption profiles of said plurality of peripherals and said fixing means comprises searching means configured to search amongst the stored profiles, for a profile corresponding to a detected peripheral.

13. Device according to claim 12 wherein said consumption profiles comprises a current consumption stabilisation time and at least one identifier of an associated peripheral.

14. Device according to claim 11, wherein that said communication ports are ports compatibles with a Universal Serial Bus standard.

15. Method for controlling the supply of electrical power of a plurality of peripherals connected to an electronic device, wherein said method comprises, for each of said plurality of peripherals, a powering step comprising:
detecting said peripheral,
starting said detected peripheral, said starting comprising:
Supplying power to said detected peripheral;
obtaining a descriptor of said detected peripheral;
fixing a temporal delay according to said obtained descriptor;
waiting for the time elapsed since the initiation of said power supplying being greater or equal to said temporal delay;
each of said powering steps of said plurality of peripherals being performed one after the other.

16. Control method according to claim 15, wherein the fixing of a temporal delay comprises searching for a profile comprising a current stabilisation time amongst stored consumption profiles, according to said obtained descriptor of said detected peripheral.

17. Control method according to claim 6, wherein, when said search is successfull, said temporal delay takes the value of said current stabilisation time.

18. Control method according to claim 16, wherein, when said search is unsuccessful, said temporal delay takes a default delay value.

19. Control method according to claim 18 wherein said default delay value is a constant value.

20. Control method according to claim 18 wherein said default delay value is the product of an information providing a maximum current consumed, said information being received with said descriptor of said peripheral, with a constant.
